(19) United States
(12) Patent Application Publication
(10) Pub. No.: US 2025/0006119 A1
(43) Pub. Date: Jan. 2, 2025

(54) DISPLAY CONTROL CHIP, DISPLAY PANEL, AND RELATED DEVICE, METHOD, AND APPARATUS

(71) Applicant: VIVO MOBILE COMMUNICATION CO., LTD., Guangdong (CN)

(72) Inventor: Xiaodong RAO, Guangdong (CN)

(73) Assignee: VIVO MOBILE COMMUNICATION CO., LTD., Guangdong (CN)

(21) Appl. No.: 18/883,853

(22) Filed: Sep. 12, 2024

Related U.S. Application Data
(63) Continuation of application No. PCT/CN2023/080318, filed on Mar. 8, 2023.

(30) Foreign Application Priority Data
Mar. 14, 2022 (CN) 202210246979.5

(51) Int. Cl. G09G 3/3208; G09G 3/36

(52) U.S. Cl. CPC G09G 3/3208; G09G 3/36; G09G 2320/0673; G09G 2340/0435; G09G 2360/16

(57) ABSTRACT

A display control chip, a display panel, and a related device, method, and apparatus. The display control chip includes a display data receiving module and a frame rate switching control module. The display data receiving module is configured to receive a first image signal. The frame rate switching control module is configured to adjust a frame rate of the first image signal to a target frame rate to obtain a corresponding second image signal.

### CROSS-REFERENCE TO RELATED APPLICATIONS

This application is a continuation of International Application No. PCT/CN2023/080318 filed on Mar. 8, 2023, which claims priority to Chinese Patent Application No. 202210246979.5 filed on Mar. 14, 2022, which are incorporated herein by reference in their entireties.

### TECHNICAL FIELD

This application pertains to the field of display technologies and specifically relates to a display control chip, a display panel, and a related device, method, and apparatus.

### BACKGROUND

Discrete display chips have a wide range of applications in personal computers. As external dedicated image processing units, they can bring enhanced display effects such as higher frame rates, higher resolution, color saturation, and contrast. Moreover, with the development of the mobile internet, the demand for games and imaging has gradually expanded to mobile electronic devices such as mobile phones, leading to the widespread application of discrete display chips in mobile electronic devices.

Currently, in electronic devices, discrete display chips are placed between the system-level chip and the display screen, with the power supply, signal control, data, and frame rate synchronization signals for the discrete display chips all provided and controlled by the system-level chip. Specifically, when the display enhancement function of the discrete display chip is needed, data is processed through the internal modules of the discrete display chip before being output; and when the display enhancement function of the discrete display chip is not needed, data is directly output to the display screen through the internal pathway of the discrete display chip.

However, since both the switching of the discrete display chip and the frame rate control of the display screen need to be separately controlled by the system-level chip, the frame rate switching process based on the discrete display chip is prone to frame errors and stuttering, making it difficult to meet requirements of users for display smoothness.

### SUMMARY

Embodiments of this application aim to provide a display control chip, a display panel, and a related device, method, and apparatus.

According to a first aspect, an embodiment of this application provides a display control chip including a display data receiving module and a frame rate switching control module. The display data receiving module is configured to receive a first image signal. The frame rate switching control module is configured to adjust a frame rate of the first image signal to a target frame rate to obtain a corresponding second image signal.

According to a second aspect, an embodiment of this application provides a display panel including a display module and the display control chip described in the first aspect. The display module is electrically connected to the display control chip.

The display module receives and displays the second image signal output by the display control chip, and the display frame rate of the display module matches the target frame rate.

According to a third aspect, an embodiment of this application provides an electronic device including a system-level chip and the display panel described in the second aspect. The system-level chip is electrically connected to the display data receiving module, and the display data receiving module is configured to receive the first image signal output by the system-level chip.

According to a fourth aspect, an embodiment of this application provides a display processing method applied to the electronic device described in the third aspect. A display control chip of the electronic device includes a frame rate switching control module and a plurality of gamma modules. The method includes:
receiving, by the display data receiving module, a first image signal sent by the system-level chip;
adjusting, by the frame rate switching control module, a frame rate of the first image signal to a target frame rate to obtain a corresponding second image signal;
determining, by the plurality of gamma modules, a display parameter corresponding to the target frame rate; and
outputting corresponding display content based on the second image signal and the display parameter corresponding to the target frame rate.

According to a fifth aspect, an embodiment of this application provides a display processing apparatus applied to the electronic device described in the third aspect. A display control chip of the electronic device includes a frame rate switching control module and a plurality of gamma modules. The apparatus includes:
a sending module, configured to receive, through the display data receiving module, a first image signal sent by the system-level chip;
an adjustment module, configured to adjust, through the frame rate switching control module, a frame rate of the first image signal to a target frame rate to obtain a corresponding second image signal;
a determination module, configured to determine, through the plurality of the plurality of gamma modules, a display parameter corresponding to the target frame rate; and
an output module, configured to output corresponding display content based on the second image signal and the display parameter corresponding to the target frame rate.

According to a sixth aspect, an embodiment of this application provides an electronic device. The electronic device includes a processor and a memory. The memory stores a program or instructions executable on the processor. When the program or instructions are executed by the processor, the steps of the method according to the fourth aspect are implemented.

According to a seventh aspect, an embodiment of this application provides a readable storage medium. The readable storage medium stores a program or instructions. When the program or instructions are executed by a processor, the steps of the method according to the fourth aspect are implemented.

According to an eighth aspect, an embodiment of this application provides a chip. The chip includes a processor and a communication interface. The communication interface is coupled to the processor. The processor is configured to run a program or instructions to implement the method according to the fourth aspect.

According to a ninth aspect, an embodiment of this application provides a computer program product. The program product is stored in a storage medium. The program product is executed by at least one processor to implement the method according to the fourth aspect.

### BRIEF DESCRIPTION OF DRAWINGS

FIG. 1 is a structural diagram of a display control chip according to an embodiment of this application;

FIG. 2 is a schematic diagram of frame rate grades according to an embodiment of this application;

FIG. 3 is a schematic diagram of frame rate adjustment according to an embodiment of this application;

FIG. 4 is a first schematic diagram of frame interpolation according to an embodiment of this application;

FIG. 5 is a second schematic diagram of frame interpolation according to an embodiment of this application;

FIG. 6 is a structural diagram of a display panel according to an embodiment of this application;

FIG. 7 is a structural diagram of an electronic device according to an embodiment of this application;

FIG. 8 is a flowchart of a display processing method according to an embodiment of this application;

FIG. 9 is a flowchart of a display processing method according to another embodiment of this application;

FIG. 10 is a structural diagram of a display processing apparatus according to an embodiment of this application;

FIG. 11 is a structural diagram of an electronic device according to an embodiment of this application; and

FIG. 12 is a structural diagram of an electronic device according to another embodiment of this application.

### DETAILED DESCRIPTION

The following clearly describes the technical solutions in embodiments of this application with reference to the accompanying drawings in the embodiments of this application. Apparently, the described embodiments are some but not all embodiments of this application. All other embodiments obtained by persons of ordinary skill in the art based on the embodiments of this application fall within the protection scope of this application.

The terms “first”, “second”, and the like in this specification and claims of this application are used to distinguish between similar objects rather than to describe a specific order or sequence. It should be understood that the data used in this way is interchangeable in appropriate circumstances such that the embodiments of this application can be implemented in other orders than the order illustrated or described herein. In addition, objects distinguished by “first”, “second”, and the like are generally of the same type, and the quantities of the objects are not limited. For example, there may be one or more first objects. In addition, “and/or” in the specification and claims represents at least one of the connected objects, and the character “/” generally indicates that the contextually associated objects have an “or” relationship.

The following describes in detail the display processing method provided in the embodiments of this application through specific embodiments and application scenarios thereof with reference to the accompanying drawings.

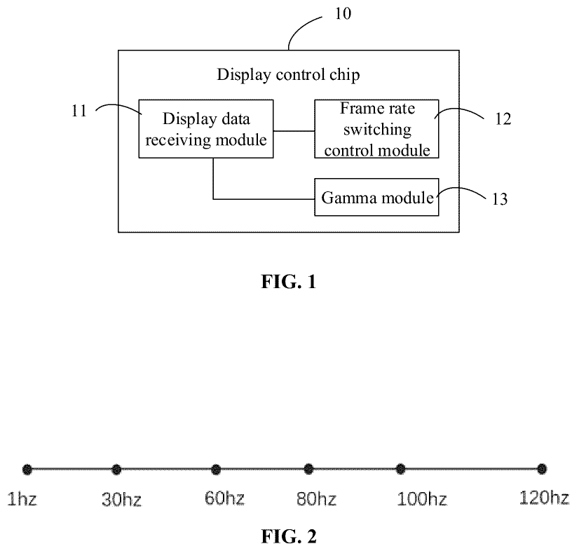

Refer to FIG. 1. FIG. 1 is a structural diagram of a display control chip according to an embodiment of this application. As shown in FIG. 1, the display control chip 10 includes a display data receiving module 11 and a frame rate switching control module 12. The display data receiving module 11 is configured to receive a first image signal. The frame rate switching control module 12 is configured to adjust a frame rate of the first image signal to a target frame rate to obtain a corresponding second image signal.

In this application, the display control chip 10 is a control chip integrated into the display panel, and based on the frame rate adjustment function of the frame rate switching control module 12 of the display control chip 10, the frame rate of the image signal can be directly adjusted on the side of the display panel, so that the frame rate of the image signal is the same as the actual display frame rate required by the display panel, thereby avoiding the problems of frame errors and stuttering in the display process of the image signal.

When the display control chip is applied in electronic devices such as mobile phones, the display data receiving module 11 can be electrically connected to a system-level chip of the electronic device to receive the first image signal output by the system-level chip.

In some embodiments, the display control chip of this application can be obtained by integrating a discrete display chip with a driving chip of the display panel, that is, the display control chip of this application can not only implement functions related to the discrete display chip (such as frame interpolation function) but also implement functions that can be implemented by the driving chip of the display panel. Moreover, by integrating the frame rate adjustment function of the discrete display chip into the display control chip, the frame rate of the image signal can be directly adjusted by the display control chip. Compared with the conventional way of adjusting the frame rate using a discrete display chip, this not only shortens the transmission path of the image signal but also reduces the problems of frame errors and stuttering that are prone to occur in the conventional frame rate adjustment process, effectively improving the frame rate adjustment effect on the image signal.

Optionally, the display control chip 10 further includes a gamma module combination 13. The gamma module combination 13 includes a plurality of gamma modules. The plurality of gamma modules are configured to calculate a display parameter corresponding to the target frame rate. The display parameter includes at least one of display brightness and color.

In this embodiment, the display parameter corresponding to the target frame rate can be calculated by the plurality of gamma modules of the display control chip 10, so that during the output process of the second image signal, the playback frame rate of the second image signal can be adapted to the display parameter calculated by the plurality of gamma modules, avoiding the problem of the playback frame rate not matching the display parameter such as display brightness or color, thereby achieving the purpose of improving the playback effect of the second image signal.

Further optionally, the plurality of gamma modules correspond one-to-one with a plurality of frame rate grades, and the plurality of frame grades are determined based on the number of gamma modules in the plurality of gamma modules and a frame rate switching range of the frame rate switching control module 12.

In this embodiment, by establishing a correspondence between the gamma modules and the frame rate grades, the display parameter corresponding to any target frame rate within the frame rate switching range of the frame rate switching control module 12 can be calculated, effectively improving the adaptability range of the gamma modules.

For example, when the frame rate switching range of the frame rate switching control module 12 is 1 Hz to 120 Hz, the plurality of gamma modules provided can calculate to obtain the display parameters corresponding to any target frame rates within the range of 1 Hz to 120 Hz. Compared to the existing support for calculating the display parameters corresponding to only 2 or 3 frame rates, this can effectively expand the calculation capability of the gamma modules, improving the image quality in the process of adjusting the frame rate of the first image signal to any target frame rate within the frame rate switching range.

Optionally, the target frame rate is between a first frame rate grade and a second frame rate grade adjacent among the plurality of frame rate grades.

The display control chip 10 further includes a calculation module 14. The calculation module 14 is configured to calculate the display parameter corresponding to the target frame rate based on a formula {(A-B)*(B-C)/M-m};
wherein, B represents the target frame rate, A represents a frame rate corresponding to the first frame rate grade, C represents a frame rate corresponding to the second frame rate grade, M represents a maximum frame rate switchable by the frame rate switching control module 12, and m represents a minimum frame rate switchable by the frame rate switching control module 12.

In this embodiment, the display parameters corresponding to the frame rates between any two adjacent frame rate grades can be calculated through the formula {(A-B)*(B-C)/M-m}.

As shown in FIG. 2, the frame rate switching range of the frame rate switching control module 12 is 1 Hz to 120 Hz, and the number of gamma modules is 6. Then, 6 frame rate grades can be set, which are 1 Hz, 30 Hz, 60 Hz, 80 Hz, 100 Hz, and 120 Hz sequentially, and the target parameters corresponding to target frame rates within the range of 1 Hz to 120 Hz can be calculated based on the aforementioned formula.

Specifically, when the target frame rate is 45 Hz, the first frame rate grade can be determined to be 30 Hz, the second frame rate grade can be determined to be 60 Hz, and the display parameter corresponding to the target frame rate can be calculated based on the formula {(A-B)*(B-C)/M-m}, thereby realizing the calculation of the display parameter corresponding to the target frame rate.

Furthermore, the frame rate switching range is between the minimum frame rate m and the maximum frame rate M switchable by the frame rate switching control module, the number of gamma modules in the plurality of gamma modules is p, the number of frame rate grades is p, and a frame rate difference between the first frame rate grade and the second frame rate grade adjacent among the plurality of frame rate grades is greater than or equal to M/p and less than or equal to 2M/p. That is, the frame rate difference between any two adjacent frame rate grades of the frame rate switching control module 12 can be determined based on the maximum switchable frame rate and the number of gamma modules in the plurality of gamma modules.

Through the above design, during the process of the frame rate switching control module 12 adjusting the frame rate of the first image signal to any target frame rate within the frame rate switching range, the combination of the plurality of gamma modules can be used in conjunction with the frame rate switching control module 12 for synchronous image quality improvement and processing, increasing the smoothness of the display screen while improving the image quality (color and brightness), and enhancing the user experience. Optionally, the frame rate switching control module 12 includes at least one of a first switching unit and a second switching unit.

The first switching unit is configured to adjust an idle interval between any two adjacent image frames in the first image signal to a target idle interval to obtain the corresponding second image signal, where the target idle interval is determined based on the target frame rate.

The second switching unit is configured to interpolate a target image frame between any two adjacent image frames in the first image signal to obtain the corresponding second image signal, where the target image frame is determined based on the target frame rate.

In this embodiment, the frame rate of the first image signal can be adjusted to any frame rate by adjusting the idle interval between adjacent image frames and/or by interpolating frames, so that the target frame rate is continuously adjustable within the frame rate switching range. For example, when the adjustment of the frame rate is large, the frame rate can be increased by folds through frame interpolation.

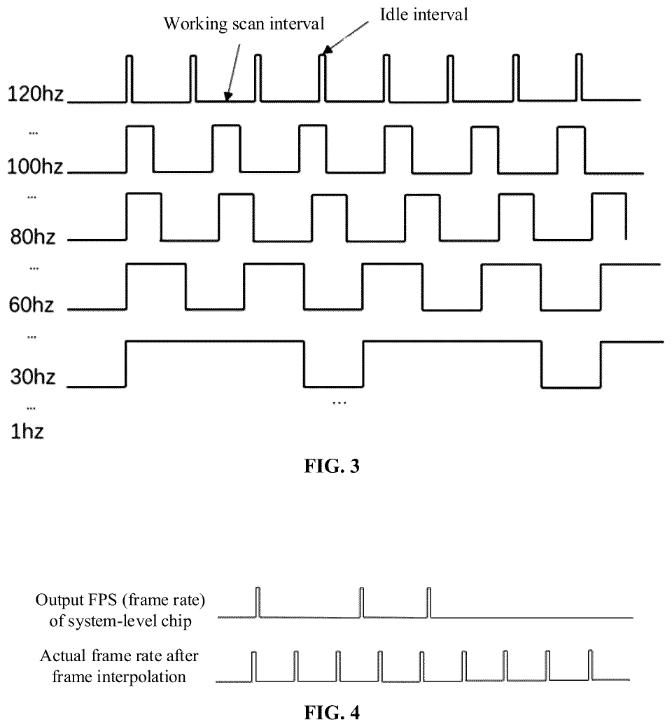

As shown in FIG. 3, when the frame rate switching range of the frame rate switching control module 12 is 1 Hz to 120 Hz, the 120 Hz frame rate can be used as a base, and for frame rates from 1 Hz to 119 Hz, the idle (Prouch) interval can be increased based on 120 Hz, thereby achieving stepless frame rate switching.

The number of interpolated target image frames can be set based on actual needs.

Thus, through the frame interpolation function of the frame rate switching control module 12, the frame rate and frame interpolation function can be uniformly controlled, making the display of the display panel smoother.

As shown in FIG. 4, through frame interpolation, the unstable frame rate output by the system-level chip is changed into a stable 120 Hz, making the display of the display panel smoother, allowing users to enjoy a smoother experience while playing games, shopping online, and browsing social media.

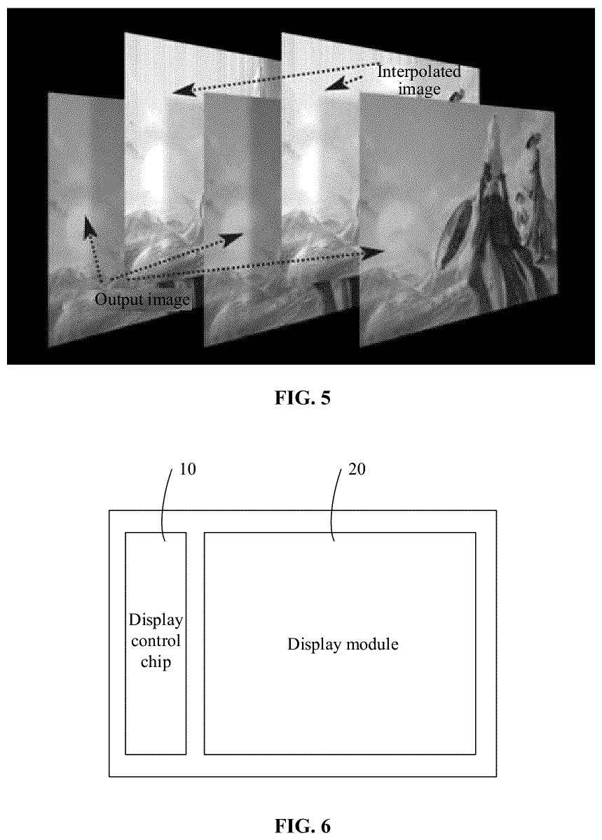

As shown in FIG. 5, if the frame rate of the image signal output by the system-level chip is 45FPS, the frame rate can be increased to 90 Hz by interpolating target image frames in the middle of the signal with the original refresh frame rate, that is, the frame rate can be doubled by interpolating a target image frame between any two adjacent image frames of the image signal output by the system-level chip.

It can be understood that the target frame rate mentioned in the above examples can be any frame rate value within the frame rate switching range of the frame rate switching control module 12.

In actual use, an association between application scenarios and frame rate modes can also be established, so that the corresponding frame rate mode can be selected based on the application scenario to output display content. For example, when the application scenario associated with the display content output is a dynamic scene, a high frame rate mode can be selected to output the corresponding image to improve the smoothness and dynamic effect of the display content; correspondingly, when the display content output the application scenario associated with is a static scene, a low frame rate mode can be selected to output the corresponding image to reduce the power consumption required during the display process and achieve the purpose of saving power.

It should be noted that the frame rate mode can be determined not only based on the application scenario of the display content but also based on the user's input operation. For example, when a sliding operation on the display interface by the user is received, the frame rate mode of the current display content can be switched to a high frame rate mode; correspondingly, when a long press operation on the display interface by the user is received, the frame rate mode of the current display content can be switched to a low frame rate mode, thereby achieving quick switching of the frame rate mode.

The high frame rate mode and the low frame rate mode can be determined based on settings of the user, which are not specifically limited herein.

Additionally, the application scenarios mentioned in the above embodiments include but are not limited to dynamic scenes and static scenes; correspondingly, the frame rate modes mentioned in the above embodiments include but are not limited to the high frame rate mode and low frame rate mode.

It can be understood that the switching of the frame rate mode can be executed by the frame rate switching control module 12. Specifically, by analyzing image content associated with the first image signal and obtaining an application scenario corresponding to the image content, the frame rate mode can be determined based on the application scenario. In addition, the frame rate mode switching information output by the system-level chip can be received, where the frame rate mode switching information is determined based on the user's input operation on the display interface and is used to indicate switching of the frame rate mode. Thus, switching between frame rates is achieved based on the user's input operation, improving the display effect of the display content.

Refer to FIG. 6. FIG. 6 is a structural diagram of a display panel according to an embodiment of this application. As shown in FIG. 6, the display panel includes a display module 20 and the display control chip 10 described in the above embodiments. The display module 20 is electrically connected to the display control chip 10.

The display module 20 is configured to receive and display the second image signal output by the display control chip 10, and the display frame rate of the display module 20 matches the target frame rate.

In some embodiments, the display module 20 includes a display part and a driving part electrically connected to the display part. The driving part drives the display part to display images, and the display control chip 10 can be integrated into the driving part. The display frame rate of the display module 20 is the same as the target frame rate.

It should be noted that the implementation method of the display control chip embodiment described above is also applicable to the embodiment of the display panel with the same technical effect achieved. Details are not repeated herein.

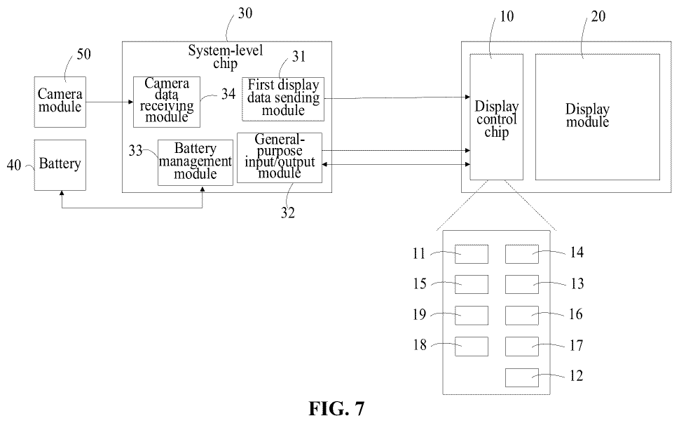

Refer to FIG. 7. FIG. 7 is a structural diagram of an electronic device according to an embodiment of this application. As shown in FIG. 7, the electronic device includes a system-level chip 30 and the display panel described in the above embodiments. The system-level chip 30 is electrically connected to the display data receiving module 11, and the display data receiving module 11 is configured to receive the first image signal output by the system-level chip 30.

As shown in FIG. 7, the system-level chip 30 includes a first display data sending module 31, a general-purpose input/output module 32, a battery management module 33, and a camera data receiving module 34.

The display control chip 10 includes a display data receiving module 11, a frame rate switching control module 12, a gamma module combination 13, a second display data sending module 14, a power control module 15, a timing control module 16, a data buffer 17, a frame rate synchronization module 18, and a signal processing module 19.

The first display data sending module 31 is in communication connection with the display data receiving module 11. In one example, the first display data sending module 31 can send display data to the display data receiving module 11 based on the mobile industry processor interface (MIPI) communication protocol.

The general-purpose input/output module 32 can exchange data with the signal processing module 19 (for example, exchange of control signals and data signals), and the frame rate synchronization module 18 works together to synchronize the frame rate of the image signal output by the system-level chip 30 with the image display frame rate of the display panel, achieving the purpose of improving the smoothness of the display content of the display panel.

The battery management module 33 may be electrically connected to a battery 40 of the electronic device to manage performance parameters of the battery 40. In addition, the battery management module 33 may also be electrically connected to the power control module 15 to control the power control module 15 to generate logic voltage, analog voltage, and the like required by the display panel.

The camera data receiving module 34 may be electrically connected to a camera module 50 of the electronic device to enable data exchange between the camera module 50 and the system-level chip 30.

The frame rate switching control module 12 can adjust the frame rate of the image signal, and the gamma module combination 13 can adjust the brightness and color of the display content, thereby achieving the purpose of improving the display effect of the display content.

For example, the first display data sending module 31 of the system-level chip 30 may send display data to the display data receiving module 11 based on the MIPI communication protocol. The display data received by the display data receiving module 11 may be stored in the data buffer 17. The system-level chip 30 may also control the power control module 15 to generate the logic voltage, analog voltage, and the like required by the display panel. The frame rate switching control module 12 and the gamma module combination 13 may process the display data stored in the data buffer 17.

For example, when the frame interpolation function of the frame rate switching control module 12 is needed, the frame rate switching control module 12 can perform frame interpolation processing on the frame rate of the display data, and the gamma module combination 13 can calculate the corresponding display parameter based on the actual frame rate after frame interpolation, to achieve the adjustment of the frame rate and gamma value of the display data stored in the data buffer 17.

In this application, the display control chip 10 is obtained by integrating a discrete display chip and a driving chip of the display panel, so that the display control chip 20 can not only implement functions that can be implemented by the discrete display chip but also implement functions that can be implemented by the driving chip of the display panel, and the system-level chip 30 can directly control the display control chip 10, simplifying the signal flow between the system-level chip 30 and the display control chip 10. Moreover, compared to the existing technology where a discrete display chip is disposed between the system-level chip 30 and the driving chip of the display panel, the electronic device provided in the embodiments of this application does not need a power supply system corresponding to the discrete display chip, effectively reducing the energy consumption of the system, and effectively improving the endurance of the electronic device.

In addition, by using the display control chip 10 of this application, it is also possible to alleviate the frame error problem caused by the system-level chip separately controlling the discrete display chip and the driving chip of the display panel as in the existing technology, and achieve unified control of the discrete display chip and the driving chip of the display panel, so that the screen frame rate can be set according to the frame rate output by the application software on the electronic device, achieving stepless frame rate switching and improving the smoothness of the display content of the display panel.

It should be noted that the implementation method of the display panel embodiment described above is also applicable to the embodiment of the electronic device with the same technical effect. Details are not repeated herein.

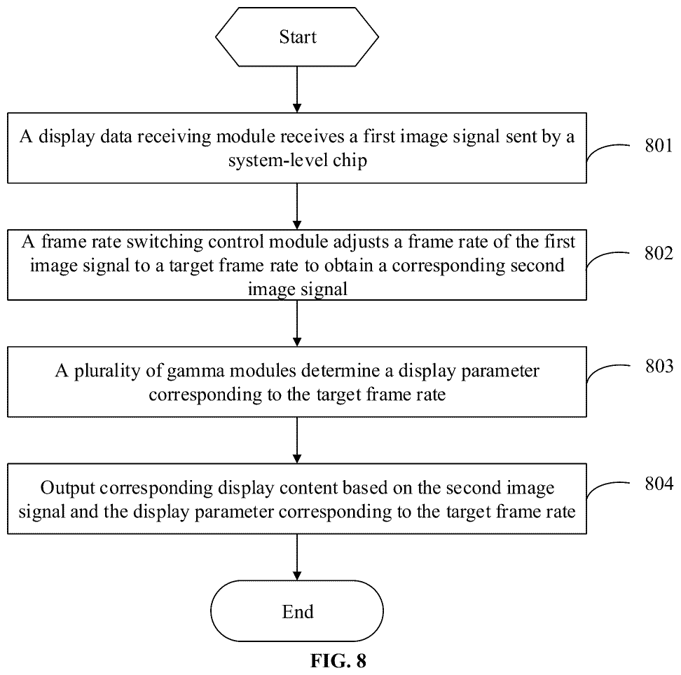

Refer to FIG. 8. FIG. 8 is a flowchart of a display processing method according to an embodiment of this application. As shown in FIG. 8, the method can be applied to the electronic device shown in FIG. 7 and includes the following steps:

Step 801. A display data receiving module receives a first image signal sent by the system-level chip.

In this step, the first image signal sent by a first display data sending module of the system-level chip can be received based on the communication connection between the display data receiving module of the display control chip and the first display data sending module of the system-level chip.

After the display data receiving module receives the first image signal sent by the system-level chip, the received first image signal may be stored in the data buffer of the display control chip, so that other modules of the display control chip are able to process the first image signal, for example, adjusting the brightness and color of the image frames in the first image signal, or adjusting the frame rate of the first image signal.

Step 802. The frame rate switching control module adjusts a frame rate of the first image signal to a target frame rate to obtain a corresponding second image signal.

In this step, the frame rate of the first image signal may be adjusted to the target frame rate by the frame rate switching control module of the display control chip, to achieve the adjustment of the frame rate of the image signal.

Specifically, the frame rate adjustment of the image signal can be achieved by inserting idle intervals or directly interpolating frames.

Step 803. The plurality of gamma modules determine a display parameter corresponding to the target frame rate.

In this step, the display parameters corresponding to the target frame rate may be calculated by the gamma modules, so that when the second image signal is output, the playback frame rate of the second image signal can be adapted to the display parameter, avoiding the problem of the playback frame rate not matching the display parameter such as display brightness and color, thereby achieving the purpose of improving the playback effect of the second image signal.

Step 804. Output corresponding display content based on the second image signal and the display parameter corresponding to the target frame rate.

In this step, the second image signal and the display parameter corresponding to the target frame rate may be synthesized being output, or the second image signal may be adjusted based on the display parameter corresponding to the target frame rate before being output, to output the corresponding display content, thereby achieving the purpose of improving the output effect of the corresponding image signal.

For example, in the case where the discrete display chip and the driving chip of the display panel are provided separately, the driving chip of the display panel only supports fixed frame rates, such as 60 Hz (Hz indicating screen frame rate), 90 Hz, and 120 Hz. However, different application software outputs at different frame rates, such as 45 frames per second (FPS), 30FPS, 24FPS, or 48FPS, which can cause frame errors, stuttering, and a lack of smoothness when the display panel displays the corresponding image signal.

With the display processing method provided in the embodiments of this application, the frame rate of the image signal can be adjusted to the target frame rate (including but not limited to 60 Hz, 90 Hz, and 120 Hz) by the frame rate switching control module of the display control chip, effectively avoiding frame errors, stuttering, and a lack of smoothness during the display process of the image signal.

Furthermore, since the display control chip can not only achieve the functions that can be achieved by the discrete display chip but also the functions that can be achieved by the driving chip of the display panel, when the system-level chip communicates with the display control chip, the system-level chip can have unified control of the display frame rate, and the frame rate output by the system-level chip can be synchronized with the frame rate received by the display control chip, without excessive intermediate processing, thereby effectively mitigating the issues of frame errors, stuttering, and delays during the frame rate switching process.

Optionally, the step of adjusting a frame rate of the first image signal to a target frame rate by the frame rate switching control module to obtain a corresponding second image signal includes:
adjusting an idle interval between any two adjacent image frames in the first image signal to the target idle interval to obtain the corresponding second image signal, the target idle interval is determined based on the target frame rate.

In this embodiment, the frame rate can be adjusted by adjusting the idle interval between any two adjacent image frames in the first image signal, thereby changing the first image signal into the second image signal.

As shown in FIG. 3, the frame rate of 120 Hz can be used as a base, and for frame rates from 1 Hz to 119 Hz, the idle (Prouch) interval can be increased based on 120 Hz, thereby achieving stepless frame rate switching.

Optionally, the step of adjusting a frame rate of the first image signal to a target frame rate by the frame rate switching control module to obtain a corresponding second image signal includes:
interpolating a target image frame between any two adjacent image frames in the first image signal to obtain the corresponding second image signal, where the target image frame is determined based on the target frame rate.

In this embodiment, the frame rate of the image signal can be adjusted by interpolating a target image frame between any two adjacent image frames.

The number of interpolated target image frames can be set based on actual needs.

Thus, through the frame interpolation function of the frame rate switching control module, the frame rate and frame interpolation function can be uniformly controlled, making the display of the display panel smoother.

As shown in FIG. 4, the unstable frame rate output by the system-level chip is changed into a stable 120 Hz through frame interpolation, making the display of the display panel smoother, allowing users to enjoy a smoother experience while playing games, online shopping, and browsing social media.

As shown in FIG. 5, if the frame rate of the image signal output by the system-level chip is 45FPS, by interpolating target image frames in the middle of the signal with the original refresh frame rate, the frame rate can be increased to 90 Hz, that is, by interpolating a target image frame between any two adjacent image frames of the image signal output by the system-level chip, the frame rate can be doubled.

The display processing method provided by the embodiments of this application involves receiving the first image signal sent by the system-level chip by the display data receiving module; adjusting the frame rate of the first image signal to a target frame rate by the frame rate switching control module to obtain a corresponding second image signal; determining a display parameter corresponding to the target frame rate by the plurality of gamma modules; and outputting corresponding display content based on the second image signal and the display parameter corresponding to the target frame rate. This method can achieve the purpose of mitigating frame errors and stuttering during the frame rate switching process.

The display processing method provided in the embodiments of this application may be executed by a display processing apparatus. In the embodiments of this application, the display processing apparatus provided in an embodiment of this application is described using the display processing apparatus performing the display processing method as an example.

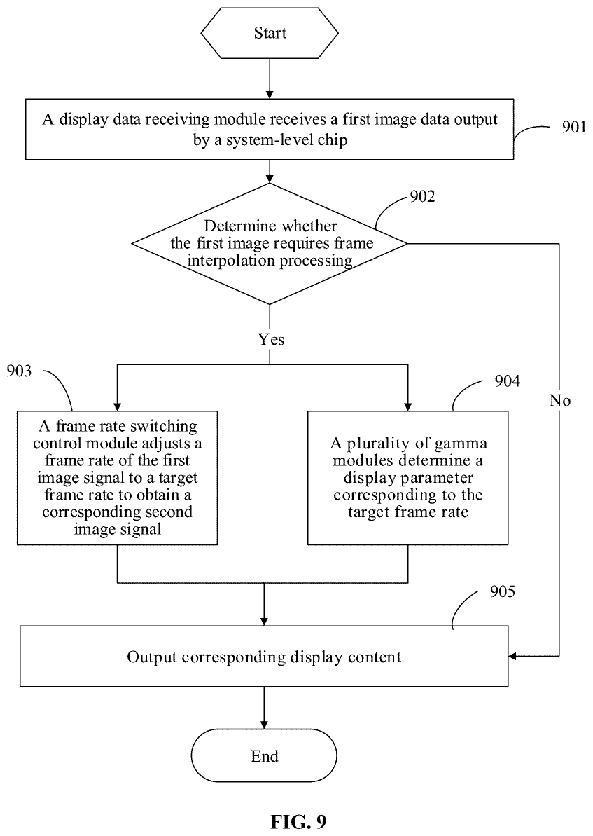

Refer to FIG. 9. FIG. 9 is a flowchart of a display processing method according to another embodiment of this application. As shown in FIG. 9, the method can be applied to the electronic device shown in FIG. 7 and includes the following steps:

Step 901. The display data receiving module receives a first image signal output by the system-level chip.

After receiving the first image signal sent by the system-level chip, the display data receiving module can store the received first image signal in the data buffer of the display control chip, so that other modules of the display control chip are able to process the first image signal. Step 902. Determine whether the first image signal requires frame interpolation processing.

If the first image signal requires frame interpolation, then steps 903 and 904 are executed. If the first image signal does not require frame interpolation, then step 905 is executed.

Step 903. The frame rate switching control module adjusts a frame rate of a first image signal to a target frame rate to obtain a corresponding second image signal.

Step 904. The plurality of gamma modules determine a display parameter corresponding to the target frame rate.

Step 905. Output corresponding display content.

When the corresponding display content is determined based on steps 903 and 904, the corresponding display content is output based on the second image signal and the display parameter corresponding to the target frame rate. When the received first image signal does not require frame interpolation processing, the corresponding display content can be output directly based on the frame rate and associated display parameter of the first image signal output by the system-level chip. That is, the corresponding display content can be determined based on the first image signal and the display parameter corresponding to the frame rate of the first image signal, thus outputting the corresponding display content, such as displaying a corresponding image.

Optionally, steps 903 and 904 can be performed simultaneously to increase the processing speed, improving the smoothness of the display screen and enhancing image quality (color and brightness), thereby enhancing the user experience.

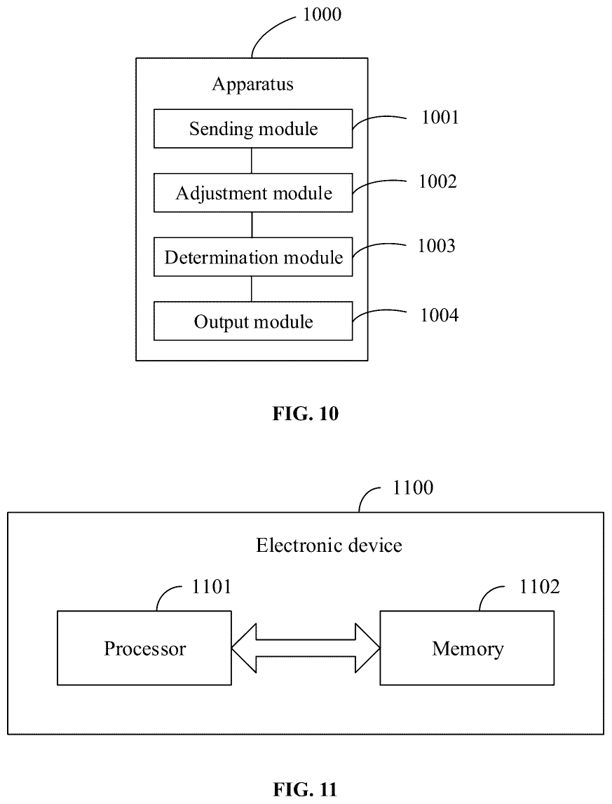

As shown in FIG. 10, an embodiment of the application also provides a display processing apparatus. This apparatus 1000 is applied to an electronic device. A display control chip of the electronic device includes a frame rate switching control module and a plurality of gamma modules. The apparatus 1000 includes:
a sending module 1001, configured to receive, through the display data receiving module, a first image signal sent by the system-level chip;
an adjustment module 1002, configured to adjust, through the frame rate switching control module, a frame rate of the first image signal to a target frame rate to obtain a corresponding second image signal;
a determination module 1003, configured to determine, through the plurality of gamma modules, a display parameter corresponding to the target frame rate; and
an output module 1004, configured to output corresponding display content based on the second image signal and the display parameter corresponding to the target frame rate.

The display processing apparatus in this embodiment of this application may be an electronic device or a component within an electronic device, such as an integrated circuit or chip. The electronic device may be a terminal or a device other than terminals. For example, the electronic device may be a mobile phone, tablet computer, laptop, handheld computer, in-vehicle electronic device, mobile internet device (MID), augmented reality (AR)/virtual reality (VR) device, robot, wearable device, ultra-mobile personal computer (UMPC), netbook, or personal digital assistant (PDA), or the like. It may also be a network attached storage (NAS), personal computer (PC), television (TV), teller machine, self-service machine, or the like. This is not limited by the embodiments of this application.

The display processing apparatus in this embodiment of this application may be an apparatus having an operating system. The operating system may be an Android operating system, an iOS operating system, or another possible operating system. This is not specifically limited in the embodiments of this application.

The display processing apparatus provided in the embodiments of this application can implement the processes implemented in the method embodiment in FIG. 8. To avoid repetition, details are not further described herein.

Optionally, as shown in FIG. 11, an embodiment of this application further provides a communication device 1100 including a processor 1101 and a memory 1102. The memory 1102 stores a program or instructions capable of running on the processor 1101. When the program or the instructions are executed by the processor 1101, the steps of the foregoing embodiment of the display processing method are implemented, with the same technical effects achieved. To avoid repetition, details are not described herein again.

It should be noted that the electronic device in the embodiment of this application includes the foregoing mobile electronic device and non-mobile electronic device.

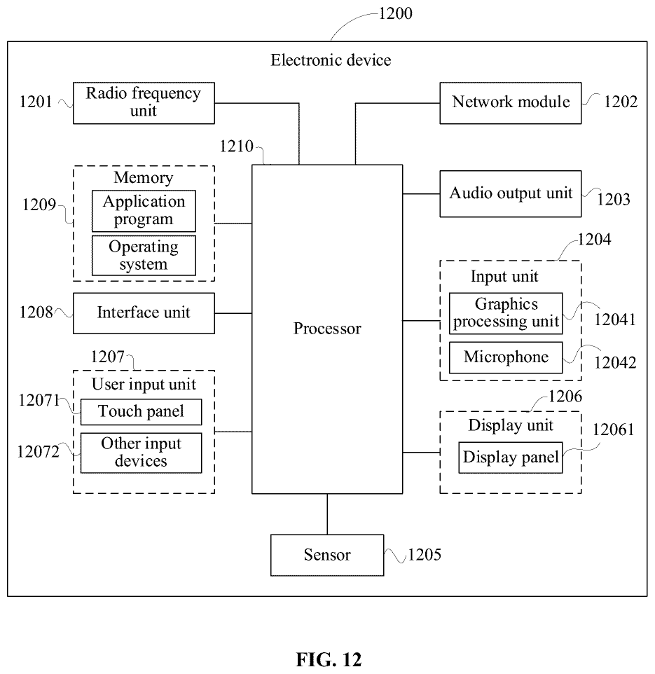

FIG. 12 is a schematic diagram of a hardware structure of an electronic device according to an embodiment of this application.

The electronic device 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

It can be understood by those skilled in the art that the electronic device 1200 may further include a power supply (for example, a battery) supplying power to the components. The power supply may be logically connected to the processor 1210 via a power management system so that functions such as charge management, discharge management, and power consumption management are implemented via the power management system. The structure of the electronic device shown in FIG. 12 does not constitute a limitation on the electronic device. The electronic device may include more or fewer components than shown in the drawing, combine some of the components, or arrange the components differently. Details are not described herein.

The processor 1210 is configured to receive, using the display data receiving module, a first image signal sent by the system-level chip; adjust a frame rate of the first image signal to a target frame rate using the frame rate switching control module to obtain a corresponding second image signal; determine a display parameter corresponding to the target frame rate using the plurality of gamma modules; and output corresponding display content based on the second image signal and the display parameter corresponding to the target frame.

It should be understood that in an embodiment of this application, the input unit 1204 may include a graphics processing unit (GPU) 12041 and a microphone 12042. The graphics processing unit 12041 processes image data of a static picture or video obtained by an image capture apparatus (such as a camera) in an image capture or video capture mode. The display unit 1206 may include a display panel 12061. The display panel 12061 may be configured in the form of a liquid crystal display, an organic light-emitting diode display, or the like. The user input unit 1207 includes at least one of a touch panel 12071 and other input devices 12072. The touch panel 12071 is also referred to as a touchscreen. The touch panel 12071 may include two parts: a touch detection apparatus and a touch controller. Specifically, the other input devices 12072 may include but are not limited to a physical keyboard, a function button (for example, volume control button or on/off button), a trackball, a mouse, and a joystick. Details are not described herein.

The memory 1209 may be configured to store software programs and various data. The memory 1209 may include a first storage area for storing programs or instructions and a second storage area for storing data. The first storage area may store an operating system, an application program or instructions required by at least one function (for example, a sound play function or an image play function), and the like. Additionally, the memory 1209 may be a volatile memory or a non-volatile memory, or the memory 1209 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM). The memory 1209 in the embodiments of this application includes but is not limited to these or any other applicable types of memories.

The processor 1210 may include one or more processing units. Optionally, the processor 1210 may integrate an application processor and a modem processor. The application processor primarily processes operations involving an operating system, user interface, application program, or the like. The modem processor primarily processes radio communication signals, for example, being a baseband processor. It can be understood that the modem processor may alternatively be not integrated into the processor 1210.

An embodiment of this application further provides a readable storage medium. The readable storage medium stores a program or instructions. When the program or instructions are executed by a processor, the processes of the foregoing display processing method embodiments are implemented, with the same technical effects achieved. To avoid repetition, details are not described herein again.

The processor is the processor in the electronic device in the foregoing embodiments. The readable storage medium includes a computer-readable storage medium such as a computer read-only memory ROM, a random access memory RAM, a magnetic disk, or an optical disc.

Another embodiment of this application provides a chip. The chip includes a processor and a communication interface. The communication interface is coupled to the processor. The processor is configured to run a program or instructions to implement the processes of the foregoing display processing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program product. The program product is stored in a readable storage medium. The program product is executed by at least one processor to implement the processes of the foregoing display processing method embodiments, with the same technical effects achieved. To avoid repetition, details are not described herein again.

It should be noted that the terms “include”, “comprise”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. Without more constraints, an element preceded by “includes a . . . ” does not preclude the presence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

Based on the above description of embodiments, persons skilled in the art can clearly understand that the method in the foregoing embodiments can be implemented through software on a necessary hardware platform or certainly through hardware only, but in many cases, the former is the more preferred implementation. Based on such an understanding, the technical solutions of this application essentially, or the part contributing to the prior art may be implemented in the form of a computer software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the method described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other forms without departing from the principle of this application and the protection scope of the claims, and all such forms fall within the protection scope of this application.

What is claimed is:

1. A display control chip, comprising a display data receiving module and a frame rate switching control module, wherein the display data receiving module is configured to receive a first image signal; and the frame rate switching control module is configured to adjust a frame rate of the first image signal to a target frame rate to obtain a corresponding second image signal.

2. The display control chip according to claim 1, wherein the display control chip further comprises a plurality of gamma modules, and the plurality of gamma modules are configured to calculate a display parameter corresponding to the target frame rate, wherein
the display parameter comprises at least one of display brightness or color.

3. The display control chip according to claim 2, wherein the plurality of gamma modules correspond one-to-one with a plurality of frame rate grades, and the plurality of frame rate grades are determined based on the number of gamma modules in the plurality of gamma modules and a frame rate switching range of the frame rate switching control module.

4. The display control chip according to claim 3, wherein the target frame rate is between a first frame rate grade and a second frame rate grade adjacent among the plurality of frame rate grades; and
the display control chip further comprises a calculation module, the calculation module being configured to calculate the display parameter corresponding to the target frame rate based on a formula {(A-B)*(B-C)/M-m}, wherein
B represents the target frame rate, A represents a frame rate corresponding to the first frame rate grade, C represents a frame rate corresponding to the second frame rate grade, M represents a maximum frame rate switchable by the frame rate switching control module, and m represents a minimum frame rate switchable by the frame rate switching control module.

5. The display control chip according to claim 3, wherein the frame rate switching range is between the minimum frame rate m and the maximum frame rate M switchable by the frame rate switching control module, the number of gamma modules in the plurality of gamma modules is p, the number of frame rate grades is p, and a frame rate difference between the first frame rate grade and second frame rate grade adjacent among the plurality of frame rate grades is greater than or equal to M/p and less than or equal to 2M/p.

6. The display control chip according to claim 1, wherein the frame rate switching control module comprises at least one of a first switching unit or a second switching unit;
the first switching unit is configured to adjust an idle interval between any two adjacent image frames in the first image signal to a target idle interval to obtain the corresponding second image signal, wherein the target idle interval is determined based on the target frame rate; and
the second switching unit is configured to interpolate a target image frame between any two adjacent image frames in the first image signal to obtain the corresponding second image signal, wherein the target image frame is determined based on the target frame rate.

7. The display control chip according to claim 2, wherein the frame rate switching control module comprises at least one of a first switching unit or a second switching unit;
the first switching unit is configured to adjust an idle interval between any two adjacent image frames in the first image signal to a target idle interval to obtain the corresponding second image signal, wherein the target idle interval is determined based on the target frame rate; and
the second switching unit is configured to interpolate a target image frame between any two adjacent image frames in the first image signal to obtain the corresponding second image signal, wherein the target image frame is determined based on the target frame rate.

8. The display control chip according to claim 3, wherein the frame rate switching control module comprises at least one of a first switching unit or a second switching unit;
the first switching unit is configured to adjust an idle interval between any two adjacent image frames in the first image signal to a target idle interval to obtain the corresponding second image signal, wherein the target idle interval is determined based on the target frame rate; and
the second switching unit is configured to interpolate a target image frame between any two adjacent image frames in the first image signal to obtain the corresponding second image signal, wherein the target image frame is determined based on the target frame rate.

9. The display control chip according to claim 4, wherein the frame rate switching control module comprises at least one of a first switching unit or a second switching unit;
the first switching unit is configured to adjust an idle interval between any two adjacent image frames in the first image signal to a target idle interval to obtain the corresponding second image signal, wherein the target idle interval is determined based on the target frame rate; and
the second switching unit is configured to interpolate a target image frame between any two adjacent image frames in the first image signal to obtain the corresponding second image signal, wherein the target image frame is determined based on the target frame rate.

10. The display control chip according to claim 5, wherein the frame rate switching control module comprises at least one of a first switching unit or a second switching unit;
the first switching unit is configured to adjust an idle interval between any two adjacent image frames in the first image signal to a target idle interval to obtain the corresponding second image signal, wherein the target idle interval is determined based on the target frame rate; and
the second switching unit is configured to interpolate a target image frame between any two adjacent image frames in the first image signal to obtain the corresponding second image signal, wherein the target image frame is determined based on the target frame rate.

11. The display control chip according to claim 1, wherein the target frame rate is any frame rate value within the frame rate switching range of the frame rate switching control module.

12. A display panel, comprising a display module and a display control chip,
wherein the display control chip comprises a display data receiving module and a frame rate switching control module, wherein the display data receiving module is configured to receive a first image signal; and the frame rate switching control module is configured to adjust a frame rate of the first image signal to a target frame rate to obtain a corresponding second image signal, wherein the display module is electrically connected to the display control chip; and
the display module is configured to receive and display the second image signal output by the display control chip, wherein a display frame rate of the display module matches the target frame rate.

13. The display panel according to claim 12, wherein the display module comprises a display part and a driving part electrically connected to the display part, wherein the driving part drives the display part to display images and the display control chip is integrated into the driving part; and the display frame rate of the display module is the same as the target frame rate.

14. The display panel according to claim 12, wherein the display control chip further comprises a plurality of gamma modules, and the plurality of gamma modules are configured to calculate a display parameter corresponding to the target frame rate, wherein
the display parameter comprises at least one of display brightness or color.

15. The display panel according to claim 14, wherein the plurality of gamma modules correspond one-to-one with a plurality of frame rate grades, and the plurality of frame rate grades are determined based on the number of gamma modules in the plurality of gamma modules and a frame rate switching range of the frame rate switching control module.

16. The display panel according to claim 15, wherein the target frame rate is between a first frame rate grade and a second frame rate grade adjacent among the plurality of frame rate grades; and
the display control chip further comprises a calculation module, the calculation module being configured to calculate the display parameter corresponding to the target frame rate based on a formula {(A-B)*(B-C)/M-m}, wherein
B represents the target frame rate, A represents a frame rate corresponding to the first frame rate grade, C represents a frame rate corresponding to the second frame rate grade, M represents a maximum frame rate switchable by the frame rate switching control module, and m represents a minimum frame rate switchable by the frame rate switching control module.

17. The display panel according to claim 15, wherein the frame rate switching range is between the minimum frame rate m and the maximum frame rate M switchable by the frame rate switching control module, the number of gamma modules in the plurality of gamma modules is p, the number of frame rate grades is p, and a frame rate difference between the first frame rate grade and second frame rate grade adjacent among the plurality of frame rate grades is greater than or equal to M/p and less than or equal to 2M/p.

18. An electronic device, comprising a system-level chip and a display panel comprising a display module and a display control chip, wherein the display control chip comprises a display data receiving module and a frame rate switching control module, wherein the display data receiving module is configured to receive a first image signal; and the frame rate switching control module is configured to adjust a frame rate of the first image signal to a target frame rate to obtain a corresponding second image signal, wherein the display module is electrically connected to the display control chip; and
the display module is configured to receive and display the second image signal output by the display control chip, wherein a display frame rate of the display module matches the target frame rate,
wherein the system-level chip is electrically connected to the display data receiving module, and the display data receiving module is configured to receive the first image signal output by the system-level chip.

19. The electronic device according to claim 18, wherein the display module comprises a display part and a driving part electrically connected to the display part, wherein the driving part drives the display part to display images and the display control chip is integrated into the driving part; and the display frame rate of the display module is the same as the target frame rate.

20. A display processing method, applied to the electronic device according to claim 18, wherein a display control chip of the electronic device comprises a frame rate switching control module and a plurality of gamma modules, and the method comprises:
receiving, by the display data receiving module, a first image signal sent by the system-level chip;
adjusting, by the frame rate switching control module, a frame rate of the first image signal to a target frame rate to obtain a corresponding second image signal;
determining, by the plurality of gamma modules, a display parameter corresponding to the target frame rate; and
outputting corresponding display content based on the second image signal and the display parameter corresponding to the target frame rate.
